(19) United States
(12) Patent Application Publication
(10) Pub. No.: US 2026/0240110 A1
(43) Pub. Date: Aug. 20, 2026

(54) Calf-Feeding Bottle and Method of Bottle-Feeding Calves

(71) Applicants: Mandy Wilson, Danville, OH (US); Henry Wilson, Danville, OH (US)

(72) Inventors: Mandy Wilson, Danville, OH (US); Henry Wilson, Danville, OH (US)

(21) Appl. No.: 19/058,750

(22) Filed: Feb. 20, 2025

(51) Int. Cl. A01K 9/00

(52) U.S. Cl. CPC A01K 9/005

(57) ABSTRACT

A calf-feeding bottle includes an exterior container, an interior container, and a window. The interior container is attached to and positioned within the exterior container. The interior container is designed to hold milk. The interior container is smaller than the exterior container such that a vacuum space is formed between the interior container and the exterior container. An interior lip is attached to an exterior lip to seal the vacuum space. The interior lip and the exterior lip together are designed to detachably couple with an internal flange of a nipple. The window is positioned in the exterior perimeter wall and the interior perimeter wall. The window is elongated and positioned to extend along the exterior perimeter wall and interior perimeter wall to display milk in the interior container.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to feeding bottles and more particularly pertains to a new calf-feeding bottle for feeding milk to calves while maintaining the milk at a desired temperature to promote good digestion.

### (2) Description of Related Art Including Information Disclosed Under 37 CFR 1.97 and 1.98

The prior art relates to feeding bottles for both animal offspring and human children. The prior art, as best understood, does not disclose a bottle for feeding calves that utilizes a double-walled construction with a vacuum insulation between the two walls.

### (h) BRIEF SUMMARY OF THE INVENTION

An embodiment of the disclosure meets the needs presented above in a calf-feeding bottle generally comprising an exterior container, an interior container, and a window. The exterior container includes an exterior bottom wall. An exterior perimeter wall extends perpendicularly to the exterior bottom wall. An exterior neck wall extends inwardly from the exterior perimeter wall. An exterior lip projects annularly outwardly from the exterior neck wall. The interior container is attached to and positioned within the exterior container. The interior container is designed to hold milk. The interior container is smaller than the exterior container such that a vacuum space is formed between the interior container and the exterior container. The interior container includes an interior bottom wall. An interior perimeter wall extends perpendicularly to the interior bottom wall. An interior neck wall extends inwardly from the interior perimeter wall. An interior lip projects annularly outwardly from the interior neck wall. The interior lip is attached to the exterior lip to seal the vacuum space. The interior lip and the exterior lip together are designed to detachably couple with an internal flange of a nipple. The window is positioned in the exterior perimeter wall and the interior perimeter wall. The window is elongated and positioned to extend along the exterior perimeter wall and interior perimeter wall to display milk in the interior container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a calf-feeding bottle according to an embodiment of the disclosure.

FIG. 2 is a perspective view of an embodiment of the disclosure.

FIG. 3 is a cross-sectional view of a component of the embodiment of the disclosure in FIG. 2.

FIG. 4 is cross-sectional view of the embodiment of the disclosure in FIG. 2.

FIG. 5 is a side view of an embodiment of the disclosure in use.

### (j) DETAILED DESCRIPTION OF THE INVENTION

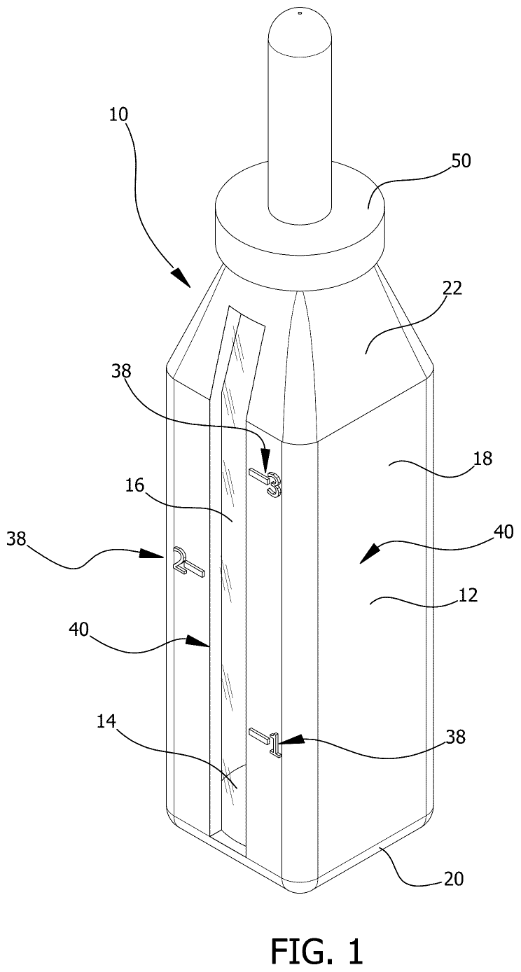

With reference now to the drawings, and in particular to FIGS. 1 through 5 thereof, a new calf-feeding bottle embodying the principles and concepts of an embodiment of the disclosure and generally designated by the reference numeral 10 will be described.

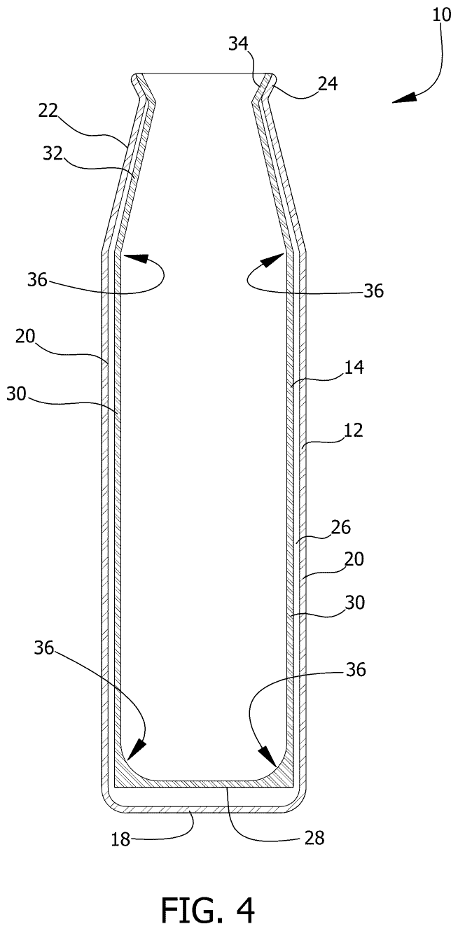

As best illustrated in FIGS. 1 through 5, the calf-feeding bottle 10 generally comprises an exterior container 12, an interior container 14, and a window 16. The exterior container 12 includes an exterior bottom wall 18. An exterior perimeter wall 20 extends perpendicularly to the exterior bottom wall 18. An exterior neck wall 22 extends inwardly from the exterior perimeter wall 20. An exterior lip 24 projects annularly outwardly from the exterior neck wall 22. The interior container 14 is attached to and positioned within the exterior container 12. The interior container 14 is designed to hold milk. The interior container 14 is smaller than the exterior container 12 such that a vacuum space 26 is formed between the interior container 14 and the exterior container 12, as best seen in FIG. 4. The interior container 14 includes an interior bottom wall 28. An interior perimeter wall 30 extends perpendicularly to the interior bottom wall 28. An interior neck wall 32 extends inwardly from the interior perimeter wall 30. An interior lip 34 projects annularly outwardly from the interior neck wall 32. The interior lip 34 is attached to the exterior lip 24 to seal the vacuum space 26. The interior lip 34 and the exterior lip 24 together are designed to detachably couple with an internal flange 52 of a nipple 50. The window 16 is positioned in the exterior perimeter wall 20 and the interior perimeter wall 30. The window 16 is elongated and positioned to extend along the exterior perimeter wall 20 and interior perimeter wall 30 to display milk in the interior container 14.

The calf-feeding bottle 10 and the vacuum space 26 could have many different shapes and designs. For example, the interior bottom wall 28 and the exterior bottom wall 18 could be in contact. The interior neck wall 32 and the exterior neck wall 22 could also be in contact, such that the vacuum space 26 only extends around the interior perimeter wall 30. The interior neck wall 32 could be omitted and an upper edge of the interior perimeter wall 30 could be joined to an upper edge of the exterior perimeter wall 20. In the exemplary embodiment, the vacuum space 26 is filled with air, though it could be filled with an insulating material, such as a foam.

Each of the exterior container 12 and the interior container 14 is stainless steel. One example is 18/8 stainless steel that is food grade for storage of the milk.

In the exemplary embodiment shown in FIG. 4, the interior container 14 includes curved transition surfaces 36 between the interior bottom wall 28 and the interior perimeter wall 30 and between the interior perimeter wall 30 and the interior neck wall 32. Such a design avoids corners where milk could be left over and bacteria could grow, and also facilitates thorough cleaning for re-use of the calf-feeding bottle 10.

The exterior perimeter wall 20 includes a plurality of markings 38 adjacent the window 16 to measure a volume of milk in the interior container 14. In the exemplary embodiment, there are three markings 38 showing the numbers 1, 2, and 3, which represent three quarts of milk. Other markings 38 could be used in different measurements, such as milliliters.

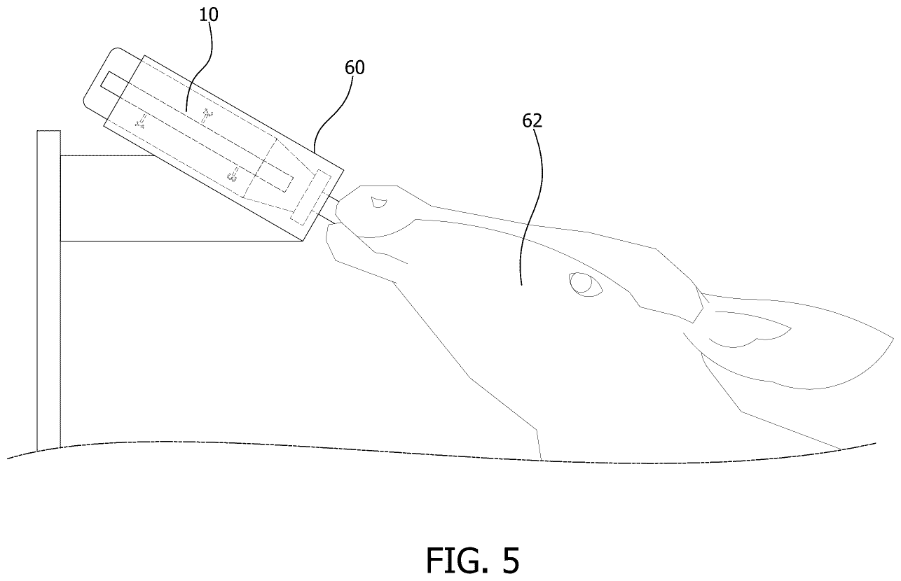

In the exemplary embodiment, the window 16 extends into the exterior neck wall 22 and the interior neck wall 32, which allows viewing of any milk in the top part of the calf-feeding bottle 10, as it is usually placed upside down in a bottle holder 60, as shown in FIG. 5. The window 16 could be made of glass or plastic.

In the exemplary embodiment, the exterior bottom wall 18 is square and the exterior perimeter wall 20 includes four exterior rectangular panels 40. This design is to fit most common designs of the bottle holder 60. In one possible embodiment, the interior bottom wall 28 could have a similar design as the interior bottom wall 28 and the interior perimeter wall 30, though the interior container 14 could also have an ovoid, pill-shaped, or rounded exterior. In the exemplary embodiment, the exterior neck wall 22 is shown as being essentially pyramid-shaped and tapers to the exterior lip 24, which is circular. However, the exterior neck wall 22 could be conical. The interior neck wall 32 could have a similar design.

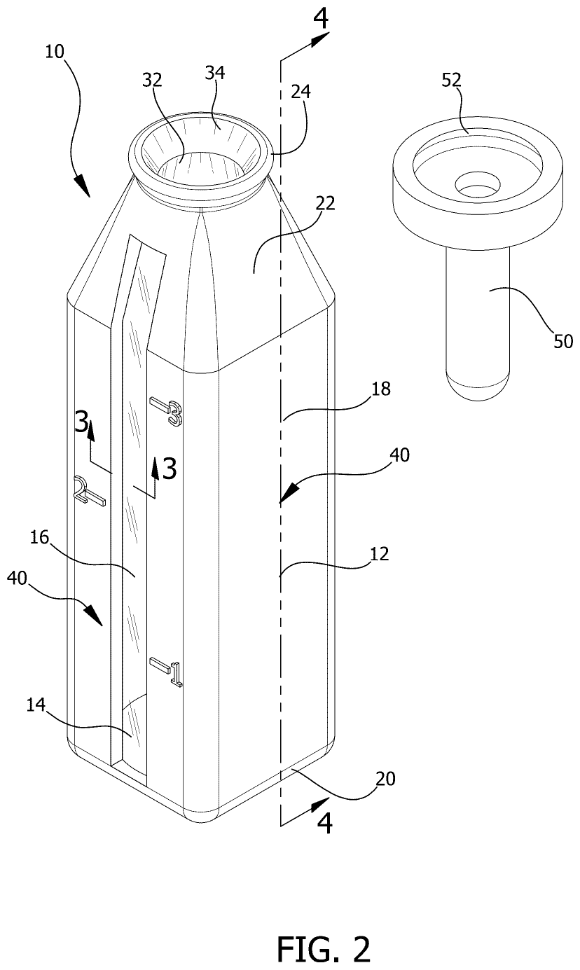

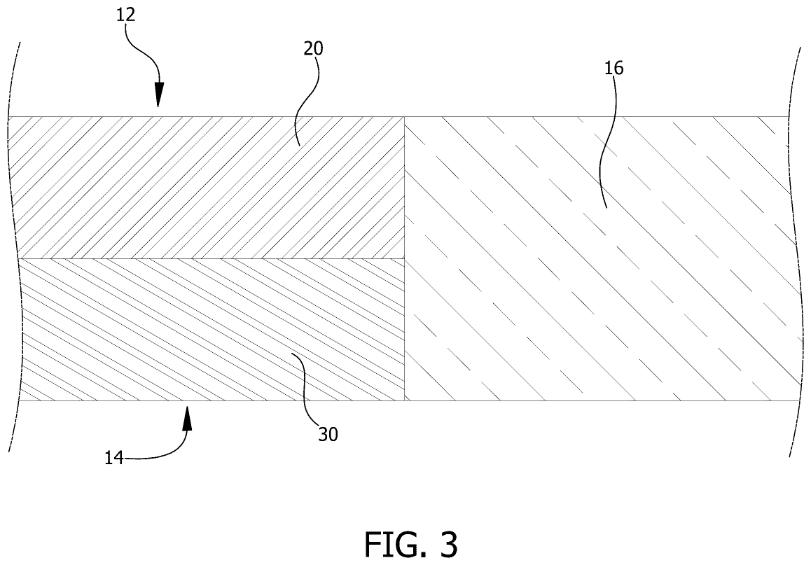

As shown in FIGS. 2 and 3, the window 16 is positioned in one of the exterior rectangular panels 40 and a respective overlapping portion of the interior container 14.

As shown in FIG. 3, the exterior container 12 and the interior container 14 can be formed such that they are in contact at the window 16, though in another possible embodiment the vacuum space 26 continues up to the window 16.

As mentioned above, the calf-feeding bottle 10 can be sized to fit a common type of bottle holder 60. In that regard, in the exemplary embodiment, opposing pairs of the exterior rectangular panels 40 are at most four inches apart. A distance from the exterior lip 24 to the exterior bottom wall 18 is at most 15 inches. The interior container 14 is designed to hold three quarts of milk. Other sizes and dimensions are within the scope of the disclosure.

The calf-feeding bottle 10 can be sold by itself or in combination with the nipple 50 having the internal flange 52 that is detachably coupled with the interior lip 34 and the exterior lip 24.

The calf-feeding bottle 10 is used to feed calves, as shown in FIG. 5. The advantage of the design is that the calf-feeding bottle 10 maintains the milk at a desired temperature to facilitate good digestion. In an exemplary method, a user fills the interior container 14 with milk, such as three quarts of milk, having a temperature in a range of 102° F. to 105° F. Other temperatures could possibly be used, but this range is well suited for calves to promote digestion and maintain core body temperature. Other liquids could also be used, though milk is most commonly used. The user then places the nipple 50 on the interior lip 34 and the exterior lip 24, which are merged to form one structure to which the nipple 50 is coupled. The user then places the calf-feeding bottle 10 in the bottle holder 60 with the nipple 50 accessible by the calf 62. The filled calf-feeding bottle 10 could also be placed in short-term storage after filling. Again, the vacuum space 26 design insulates the milk to maintain the temperature over a period of time, such as several hours. The user could therefore fill many calf-feeding bottles 10 and then transport them all together to a feeding area without risking that the calf-feeding bottles 10 filled first would be cooled to an undesirable temperature.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A calf-feeding bottle comprising:
an exterior container including:
an exterior bottom wall;
an exterior perimeter wall extending perpendicularly to said exterior bottom wall;
an exterior neck wall extending inwardly from said exterior perimeter wall; and
an exterior lip projecting annularly outwardly from said exterior neck wall;
an interior container being attached to and positioned within said exterior container, said interior container being configured to hold milk, said interior container being smaller than said exterior container such that a vacuum space is formed between said interior container and said exterior container, said interior container including:
an interior bottom wall;
an interior perimeter wall extending perpendicularly to said interior bottom wall;
an interior neck wall extending inwardly from said interior perimeter wall; and
an interior lip projecting annularly outwardly from said interior neck wall, said interior lip being attached to said exterior lip to seal said vacuum space, said interior lip and said exterior lip together being configured to detachably couple with an internal flange of a nipple; and
a window being positioned in said exterior perimeter wall and said interior perimeter wall, said window being elongated and positioned to extend along said exterior perimeter wall and said interior perimeter wall to display milk in said interior container, wherein said window extends into said exterior neck wall and said interior neck wall.

2. The calf-feeding bottle of claim 1, wherein each of said exterior container and said interior container comprises stainless steel.

3. The calf-feeding bottle of claim 1, wherein said interior container includes curved transition surfaces between said interior bottom wall and said interior perimeter wall and between said interior perimeter wall and said interior neck wall.

4. The calf-feeding bottle of claim 1, wherein said exterior perimeter wall includes a plurality of markings adjacent said window to measure a volume of milk in said interior container.

5. (canceled)

6. The calf-feeding bottle of claim 1, wherein said exterior bottom wall is square and said exterior perimeter wall includes four exterior rectangular panels.

7. The calf-feeding bottle of claim 6, wherein said window is positioned in one of said exterior rectangular panels and a respective overlapping portion of said interior container.

8. The calf-feeding bottle of claim 7, wherein opposing pairs of said exterior rectangular panels are at most four inches apart.

9. The calf-feeding bottle of claim 1, wherein a distance from said exterior lip to said exterior bottom wall is at most 15 inches.

10. The calf-feeding bottle of claim 1, wherein said interior container is configured to hold three quarts of milk.

11. The calf-feeding bottle of claim 1, further including a nipple having an internal flange being detachably coupled with said interior lip and said exterior lip.

12. The calf-feeding bottle of claim 2, wherein said interior container includes curved transition surfaces between said interior bottom wall and said interior perimeter wall and between said interior perimeter wall and said interior neck wall.

13. The calf-feeding bottle of claim 12, wherein said exterior perimeter wall includes a plurality of markings adjacent said window to measure a volume of milk in said interior container.

14. (canceled)

15. The calf-feeding bottle of claim 13, wherein:
said exterior bottom wall is square and said exterior perimeter wall includes four exterior rectangular panels;
said window is positioned in one of said exterior rectangular panels and a respective overlapping portion of said interior container; and
opposing pairs of said exterior rectangular panels are at most four inches apart.

16. The calf-feeding bottle of claim 15, wherein a distance from said exterior lip to said exterior bottom wall is at most 15 inches.

17. The calf-feeding bottle of claim 16, wherein said interior container is configured to hold three quarts of milk.

18. The calf-feeding bottle of claim 17, further including a nipple having an internal flange being detachably coupled with said interior lip and said exterior lip.

19. A method of bottle-feeding calves, said method comprising the steps of:
providing a calf-feeding bottle comprising:
an exterior container including:
an exterior bottom wall;
an exterior perimeter wall extending perpendicularly to said exterior bottom wall;
an exterior neck wall extending inwardly from said exterior perimeter wall; and
an exterior lip projecting annularly outwardly from said exterior neck wall;
an interior container being attached to and positioned within said exterior container, said interior container being configured to hold milk, said interior container being smaller than said exterior container such that a vacuum space is formed between said interior container and said exterior container, said interior container including:
an interior bottom wall;
an interior perimeter wall extending perpendicularly to said interior bottom wall;
an interior neck wall extending inwardly from said interior perimeter wall; and
an interior lip projecting annularly outwardly from said interior neck wall, said interior lip being attached to said exterior lip to seal said vacuum space, said interior lip and said exterior lip together being configured to detachably couple with an internal flange of a nipple; and
a window being positioned in said exterior perimeter wall and said interior perimeter wall, said window being elongated and positioned to extend along said exterior perimeter wall and interior perimeter wall to display milk in said interior container, wherein said window extends into said exterior neck wall and said interior neck wall;
filling said interior container with milk having a temperature in a range of 102° F. to 105° F.;
placing a nipple on said interior lip and said exterior lip; and
placing said calf-feeding bottle in a bottle holder with said nipple accessible by a calf.
